(19) United States
(12) Patent Application Publication
(10) Pub. No.: US 2004/0125796 A1
(43) Pub. Date: Jul. 1, 2004

(54) N rate, N‘precedence meter/marker

(76) Inventor: Scot A. Reader, Sherman Oaks, CA (US)

Correspondence Address: Scot A. Reader, Esq., 3424 Woodcliff Road, Sherman Oaks, CA, 91403, US

(21) Appl. No.: 10/331,686

(22) Filed: Dec. 30, 2002

(51) Int. Cl. H04L 12/50

(52) U.S. Cl. 370/359; 370/360

(57) ABSTRACT

An N-rate, N+1-precedence meter/marker for a data communication switch or router where N is a configurable number which is at least three. The N rates are limit rates which include a high boundary rate, a low boundary rate and at least one intermediate rate. The meter measures the rate of a data stream and assigns one of the N+1 precedences to packets in the data stream based on the measured rate. The marker marks packets based on the assigned one of the N+1 precedences. The data communication switch or router provides packets different levels of assurance based on their marked one of the N+1 precedences. Packets within a data stream operating at above the high boundary rate are assigned and marked with a first precedence. Packets in a data stream operating at below the high boundary rate and above the at least one intermediate rate are assigned and marked with a second precedence which is serviced with a more favorable drop profile than the first precedence. Packets in a data stream operating at below the at least one intermediate rate and above the low boundary rate are assigned and marked with a third precedence which is serviced with a more favorable drop profile than the second precedence. Packets in a data stream operating at below the low boundary rate are assigned and marked with a fourth precedence which is serviced with a more favorable drop profile than the third precedence. The high boundary rate, low boundary rate and at least one intermediate rate may comprise a peak information rate (PIR), a committed information rate (CIR) and at least one intermediate information rate (IIR), respectively.

### BACKGROUND OF THE INVENTION

Data communication switches and routers often apply rate policing to input data streams. A rate policing system often includes a meter and a marker. The meter measures the rate of a data stream and assigns a precedence to packets within the data stream based on the measured rate. The marker marks packets based on the assigned precedence. The data communication switch or router may then afford packets different levels of assurance, e.g., different probabilities of timely delivery, based on their marked precedence.

One known rate policing system of the meter/marker variety is the Two-Rate, Three-Color Marker specified in Internet Engineering Task Force Request for Comment (IETF RFC) 2698. The Two-Rate, Three-Color Marker meters an Internet Protocol (IP) data stream and marks its packets green, yellow, or red. Generally, a packet is marked red if it exceeds a peak information rate (PIR) for the data stream. A packet is marked yellow if it exceeds a committed information rate (CIR) for the data stream but does not exceed the PIR. Otherwise, a packet is marked green. A different level of assurance is then given to packets which are green, yellow and red, with green receiving the highest level of assurance and red receiving the lowest level of assurance. For example, a data communication switch or router may discard red packets, forward yellow packets as “best effort” and forward green packets with the lowest drop probability.

One limitation of the Two-Rate, Three-Color marker is the inability to provide level of assurance differentiation for packets in data streams operating between PIR and CIR. That is, the Two-Rate Three Color marker is unable to provide different levels of assurance to packets in a data stream depending on where the data stream is operating between PIR and CIR. Instead, all packets in a data stream operating between PIR and CIR are provided the same level of assurance, e.g. “best effort,” whether the data stream to which such packets belongs is operating just above CIR, equidistant from CIR and PIR, or just below PIR. In some network environments, this uniform treatment of packets in data streams operating between PIR and CIR, and more generally the limitation of the Two-Rate, Three-Color Marker to two rates and three precedences, affords an inadequate granularity of control over service differentiation.

### SUMMARY OF THE INVENTION

In a basic feature, the present invention provides an N-rate, N+1-precedence meter/marker for a data communication switch or router where N is a configurable number which is at least three. The N rates are limit rates which include a high boundary rate, a low boundary rate and at least one intermediate rate. The meter measures the rate of a data stream and assigns one of the N+1 precedences to its packets based on the measured rate. The marker marks packets based on the assigned one of the N+1 precedences. The data communication switch or router provides packets different levels of assurance based on their marked one of the N+1 precedences. Packets within a data stream operating at above the high boundary rate are assigned and marked with a first precedence. Packets in a data stream operating at below the high boundary rate and above an intermediate rate are assigned and marked with a second precedence which is provided a higher level of assurance than the first precedence. Packets in a data stream operating at below an intermediate rate and above the low boundary rate are assigned and marked with a third precedence which Is provided a higher level of assurance than the second precedence. Packets in a data stream operating at below the low boundary rate are assigned and marked with a fourth precedence which is provided a higher level of assurance than the third precedence. A higher level of assurance includes, for example, subjecting a packet to a less strict random early detection (RED) drop profile in the event the packet encounters congestion in a switching node.

In a preferred embodiment, the high boundary rate, low boundary rate and at least one intermediate rate comprise a PIR, a CIR and at least one intermediate information rate (IIR), respectively.

The present invention can be better understood by reference to the following detailed description, taken in conjunction with the accompanying drawings which are briefly described below. Of course, the actual scope of the invention is defined by the appended claims.

### BRIEF DESCRIPTION OF THE DRAWINGS

FIG. 1 shows a data communication switching node in which the present invention may be operative;

FIG. 2 shows a source line card operative within the data communication switching node of FIG. 1;

FIG. 3 shows a meter/marker operative within the source line card of FIG. 2; and

FIG. 4 shows a series of RED drop profiles for a respective series of precedences, applicable to an output queue.

### DETAILED DESCRIPTION OF THE PREFERRED EMBODIMENT

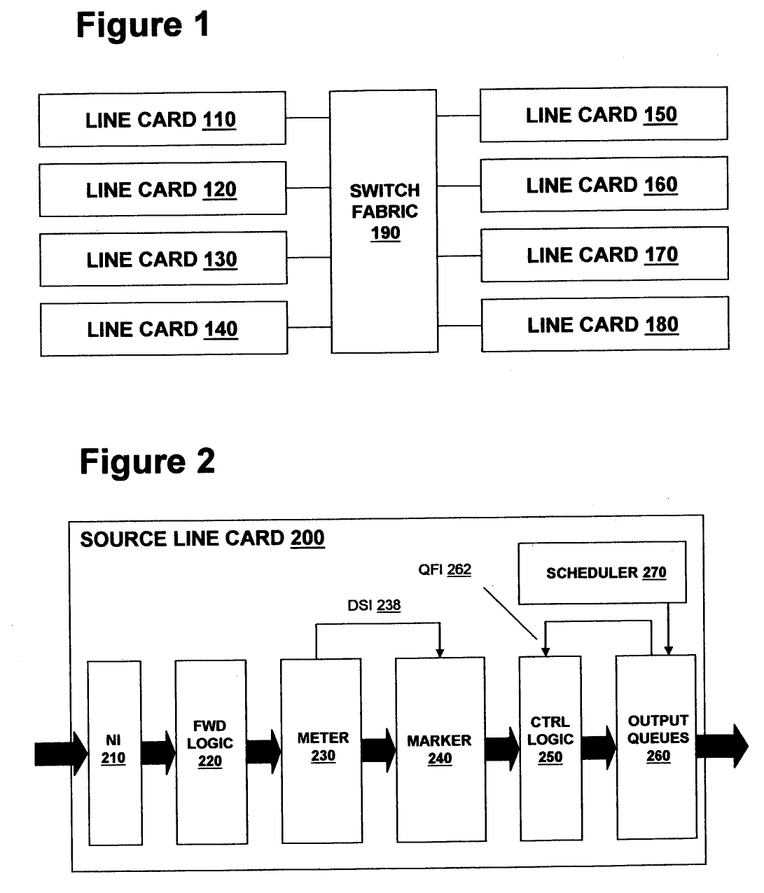

Turning to FIG. 1, a data communication switching node, such as an IP switch or an IP router, is shown. The node includes line cards 110, 120, 130, 140, 150, 160, 170, 180 interconnected across switch fabric 190. Packets arrive at source ones of line cards 110, 120, 130, 140, 150, 160, 170, 180 and are switched across switch fabric 190 to destination ones of line cards 110, 120, 130, 140, 150, 160, 170, 180 based on packet header information, such as a IP destination address. Line cards 110, 120, 130, 140, 150, 160, 170, 180 are constructed using discrete logic and programmable logic elements. Switch fabric 190 is preferably constructed using discrete logic elements. Of course, the number of line cards may vary depending on specific network requirements.

Turning to FIG. 2, a source line card 200 is shown. Source line card 200 includes network interface 210, forwarding logic 220, meter 230, marker 240, control logic 250, output queues 260 and scheduler 270. Naturally, in addition to the functionality described herein for processing packets arriving via an external network and outbound to switching fabric 190, source line card 200 may include destination line card functionality (not shown) for processing packets arriving via switching fabric 190 and outbound from the switching node.

Network interface 210 includes discrete processing logic for performing physical layer functions on packets arriving via an external network, such as receiving the packets, performing optical to electrical conversions, checking for bit errors, removing physical layer headers and passing packets to forwarding logic 220.

Forwarding logic 220 includes programmable processing logic for performing packet forwarding functions, such as resolving a destination line card and a priority for packets, discarding selected packets and editing packets. Destination line card resolution is made based on a destination IP address in IP packet headers. Priority resolution is made based on one or more Differentiated Service Code Points (DSCPs) in IP packet headers, a transport control protocol CRCP) port number in TCP packet headers, or a TCP port number in combination with a Universal Resource Identifier (URI), Multipurpose Internet Mail Extensions (MIME) type or cookie in HyperText Transfer Protocol (HTTP) packet headers. Packet editing may include, for example, appending an internal forwarding identifier to packets, which identifies the destination line card, and modifying one or more DSCPs in IP packet headers which identifies the packet priority. Forwarding logic 220 passes resolved and edited packets to meter 230.

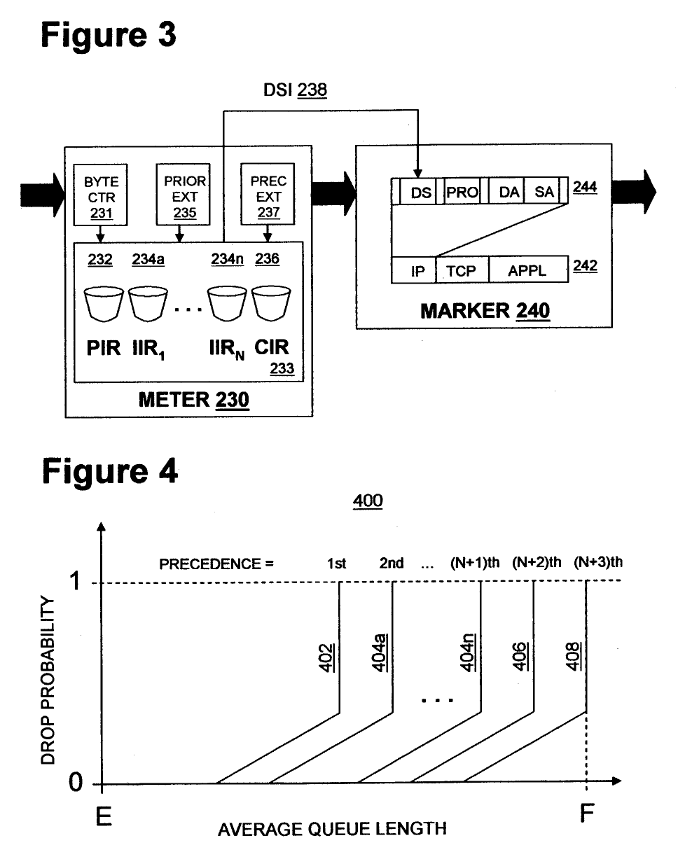

Meter 230 Includes processing logic for measuring the rate of data streams and assigning a precedence to packets within the data streams based on the measured rates and, optionally, based on preexisting DSCPs on IP packet headers. Turning to FIG. 3, meter 230 is shown in more detail. Meter 230 includes byte counter 231, token bucket logic 233, priority extraction logic 235 and precedence extraction logic 237. Byte counter 231, priority extraction logic 235 and precedence extraction logic 237 are preferably discrete logic elements. Token bucket logic 233 is preferably a programmable logic element.

Byte counter 231 counts the number of bytes in packets for subsequent application by token bucket logic 233.

Token bucket logic 233 runs token bucket algorithms to perform rate measurement and precedence assignment for packets. Token bucket logic 233 includes a series of token buckets 232, 234a, . . . 234n, 236, configurable to be three or more, which are associated with a peak information rate PIR, one or more intermediate information rates IIR₁ . . . IIR_{N}, and a committed information rate CIR, respectively. Of course, in the lower limit case where there are exactly three token buckets, there would be only one token bucket (e.g. 234) associated with an intermediate information rate IIR, i.e. the token buckets in the series would be associated with PIR, IIR and CIR, respectively. Token buckets 232, 234a, . . . 234n, 236 are initially full of tokens, i.e. the respective token counts for token buckets 232, 234a, . . . 234n, 236 are set to respective predetermined maximum token counts. Thereafter, the respective token counts for token buckets 232, 234a, . . . 234n, 236 are incremented at a rate of one times the respective information rates per second, up to the respective maximum token counts. Preferably, information rates are expressed in bytes, and tokens represent bytes.

When a packet Is metered by the token bucket series including token buckets 232, 234a, . . . 234n, 236, and token bucket logic 233 is not configured for DSCP-sensitive metering, token bucket logic 233 performs the following processing:

1. Token bucket 232 associated with PIR is checked. If the byte count of the packet exceeds the current token count for bucket 232, the packet is assigned a first precedence and a signal is sent to marker 240 on line DSI 238 indicating to mark the packet with the first precedence.

2. If the byte count of the packet does not exceed the current token count for bucket 232, token bucket 234a associated with IIR₁ is checked. If the byte count of the packet exceeds the current token count for bucket 234a, the packet is assigned a second precedence which is associated with a higher level of assurance than the first precedence and a signal is sent to marker 240 on line DSI 238 indicating to mark the packet with the second precedence. Additionally, the current token count for bucket 232 is in that event decremented by the byte count of the packet.

3. If the byte count of the packet does not exceed the current token count for bucket 234a, Step 2 is repeated successively for token buckets 234b (not shown) . . . 234n associated with rates IIR₂ through IIR_{N} until a token bucket is found, if any, for which the byte count of the packet exceeds the current token count. Token buckets associated with rates IIR₂ through IIR_{N} are associated with third through (N+1)th precedences, respectively, which are all associated with a higher level of assurance than the second precedence, and which are each associated with a higher level of assurance than the immediately preceding precedence. If a token bucket for which the byte count of the packet exceeds the current token count is found, the packet is assigned a corresponding precedence and a signal is sent to marker 240 on line DSI 238 indicating to mark the packet with the corresponding precedence. Additionally, the current token count for buckets 232, 234a and the ones of token buckets 234b . . . 234(n−1) which precede such token bucket, if any, are in that event decremented by the byte count of the packet.

4. If the byte count of the packet does not exceed the current token count for bucket 234n, the token bucket 236 associated with CIR is checked. If the byte count of the packet exceeds the current token count for bucket 236, the packet is assigned an (N+2)th precedence which is associated with a higher level of assurance than the (N+1)th precedence and a signal is sent to marker 240 on line DSI 238 indicating to mark the packet with the (N+2)th precedence. Additionally, the current token count for buckets 232 and 234a . . . 234n are in that event decremented by the byte count of the packet.

5. If the byte count of the packet does not exceed the current token count for bucket 236, the packet is assigned an (N+3)th precedence which is associated with a higher level of assurance than the (N+2)th precedence and a signal is sent to marker 240 on line DSI 238 indicating to mark the packet with the (N+3)th precedence. Additionally, the current token count for buckets 232, 234a, . . . 234n and 236 are in that event decremented by the byte count of the packet. It will be appreciated that in the lower limit case of exactly three token buckets (associated with three rates PIR, IIR and CIR, respectively), there will be four assignable precedences, and that more generally, where there are N token buckets (associated with N respective rates) there will be N+1 assignable precedences.

Meter 230 also provides DSCP-sensitive metering facilities for priority-sensitive and precedence-sensitive metering. Priority extraction logic 235 facilitates priority-sensitive metering. In priority-sensitive metering, metering is applied to individual priority data streams rather than to the entire data stream. Token bucket logic 233, rather than maintaining a single, shared series of token buckets 232, 234a, . . . 234n, 236 for application to the entire data stream, maintains discrete series of token buckets for application to different priority data streams that are constituent elements of the entire data stream. The different series of token buckets may have different numbers of token buckets and/or different PIRS, IlRs and CIRs depending on the particular priority with which they are associated. Priority extraction logic 235 examines one or more priority-related DSCPs in the IP packet header of inbound packets and token bucket logic 233 subjects the packets to the appropriate discrete series of token buckets based on the examined packet priority. Rate measurement and precedence assignment then proceed as earlier described, except that the discrete, priority-specific series of token buckets corresponding to the examined priority-related DSCPs is used in lieu of the single, shared series of token buckets 232, 234a, . . . 234n, 236.

Precedence extraction logic 237 facilitates precedence-sensitive metering. In precedence-sensitive metering, metering ensures assignment of precedences to packets that are no more favorable than preexisting precedences, e.g. precedences assigned by previous switching nodes on the packet's path. Precedence extraction logic 237 examines one or more precedence-related DSCPs in the IP packet header of inbound packets and token bucket logic 233 subjects the packets to the token bucket series corresponding to the examined precedence-related DSCPs, but limits the application of token buckets to those associated with lower precedences than the preexisting precedence. Application of token buckets associated with the same or higher precedences than the preexisting precedence is inhibited. With reference to the earlier described rate measurement and precedence assignment procedure, for example, if a packet is within the data stream metered by the single, shared token bucket series including token buckets 232, 234a . . . 234n, 236 and token bucket logic 233 is configured for precedence-sensitive metering, processing proceeds as follows:

1. If the inbound packet is marked with the first precedence, token bucket logic 233 bypasses all of token buckets 232, 234a . . . 234n, 236 and a signal is sent to marker 240 on line DSI 238 indicating to continue to mark the packet with the first precedence.

2. If the inbound packet is marked with the second precedence, token bucket logic 233 applies token bucket 232. If the byte count of the packet exceeds the current token count for bucket 232, the packet is assigned a first precedence and a signal is sent to marker 240 on line DSI 238 indicating to re-mark the packet with the first precedence. Otherwise, a signal is sent to marker 240 on line DSI 238 indicating to continue to mark the packet with the second precedence and the current token count for bucket 232 is decremented by the byte count of the packet.

3. If the inbound packet is marked with the third precedence, token bucket logic 233 first applies token bucket 232. If the byte count of the packet exceeds the current token count for bucket 232, the packet is assigned a first precedence and a signal is sent to marker 240 on line DSI 238 indicating to re-mark the packet with the first precedence. If the byte count of the packet does not exceed the current token count for bucket 232, token bucket logic 233 next applies token bucket 234a. If the byte count of the packet exceeds the current token count for bucket 234a, the packet is assigned a second precedence, a signal is sent to marker 240 on line DSI 238 indicating to re-mark the packet with the second precedence, and the current token count for bucket 232 is decremented by the byte count of the packet. Otherwise, a signal is sent to marker 240 on line DSI 238 indicating to continue to mark the packet with the third precedence and the current token count for buckets 232 and 234a are decremented by the byte count of the packet.

And so on for inbound packets marked with the fourth and any subsequent precedences.

Token bucket configuration, including the number of series of token buckets, the number of token buckets (and correspondingly the number of limit rates and precedences) within each series, the limit rate for each token bucket, the maximum token count for each token bucket, and the extent of DSCP-sensitive metering, is preferably accomplished by a network manager whose selections are downloaded using a network management protocol such as Simple Network Management Protocol (SNMP) first to a central processor (not shown) on the switching node and then to token bucket logic 233 from the central processor. Priority-sensitive metering and precedence-sensitive metering may be applied individually, or in combination. Meter 230 passes packets for which precedence has been assigned to marker 240.

Marker 240 includes discrete processing logic for marking packets based on precedence signals received on line DSI 238. Marker 240 modifies one or more of the precedence-related DSCPs in the Differentiated Services (DS) field of IP packet headers to re-mark precedence. The general format of an IP packet is shown in FIG. 3. IP packet 242 includes an IP header (IP), a TCP header CRCP) and application information (APPL), such as an HTTP header and data. The IP header includes a DS field, a protocol field (PRO), an IP destination address (DA) and an IP source address (SA). The DS field includes six bits which may be used as DSCPs defining a “per hop” behavior for the packet, as described in IERF RFC 2597, for example. Packets arriving at marker 240 include in the DS field a multi-bit priority assigned by, e.g. forwarding logic 220, and multi-bit preexisting precedence assigned by, e.g. a previous switching node along the packet's path. Marker 240, based on the precedence signals received from meter 230 on line DSI 238, overwrites the preexisting precedence with the precedence indicated on line DSI 238, which may or may not be the same as the preexisting precedence. Marker 240 passes packets for which precedence has been marked to control logic 250.

Control logic 250 includes programmable processing logic for monitoring the average length of output queues 260 and selectively discarding packets based on the monitored average queue length, the precedence of the packets and the priority of the packets.

Control logic 250 makes precedence-sensitive discard decisions with the expedient of RED algorithms. Turning to FIG. 4, an RED algorithm 400 applicable to one of output queues 260 is shown by way of illustration. RED algorithm 400 includes a series of drop profiles 402, 404a, . . . 404n, 406, 408 associated with first, second, . . . (N+1)th, (N+2)th and (N+3)th precedences, respectively, where N corresponds to the number of IIR token buckets. Of course, in the lower limit case where there are only three token buckets associated with PIR, IIR and CIR, respectively, the second and (N+1)th precedence would resolve to a single precedence and there would be only four precedences associated with data streams operating above PIR (first precedence), between PIR and IIR (second precedence), between IIR and CIR (third precedence) and below CIR (fourth precedence), respectively. Each of the drop profiles 402, 404a, . . . 404n, 406, 408 has a distinct set of drop probabilities varying between 0 and 1 as a function of average queue length, with lower precedences having less forgiving drop probabilities and higher precedences having more forgiving drop probabilities. Naturally, it is possible to associate a particular precedence with an invariant drop probability of 0 or 1, i.e. “always discard” or “always retain,” respectively, obviating a drop profile of the type shown in FIG. 4 for such precedence. For example, a strict form of rate policing may be implemented whereby control logic 250 is configured to discard all packets associated with data streams operating above PIR, i.e. all packets marked with first precedence, irrespective of the current average length of the output queue to which such packets have been or may be assigned.

Control logic 250 receives current queue length information for output queues 260 on lines QFI 262. When a packet arrives at control logic 250, the destination line card and priority of the packet are checked. An output queue associated with the destination line card and priority is selected for the packet. The precedence of the packet, assigned by meter 230 and applied by marker 240, is then checked and the packet is subjected to congestion control based on the current average queue length of the selected output queue and the packet's precedence. For example, if the selected output queue is associated with RED algorithm 400 including drop profiles 402, 404a, . . . 404n, 406, 408, the one of drop profiles 402, 404a, . . . 404n, 406, 408 corresponding to the packet's precedence is selected. The current average queue length for the selected output queue is applied to the drop profile to determine the drop probability of the packet. A random number between 0 and 1 is then generated for the packet and compared to the determined drop probability. If the random number exceeds the determined drop probability, the packet is retained and is written to the selected output queue. Otherwise, the packet is discarded.

Scheduler 270 includes programmable processing logic for scheduling packets from output queues 260 to destination line cards via switch fabric 190, preferably in accordance with a priority-sensitive algorithm, such as strict priority (SP) queueing or weighted fair queuing (WFQ).

Congestion control, output queue and scheduling configuration, including the number of output queues, the length of output queues, the output queue drop profiles for various precedences, the scheduling algorithm, and implementation details thereof, e.g. WFQ queue weight assignments is preferably accomplished by a network manager, whose selections are downloaded using a network management protocol, e.g. SNMP, first to a central processor (not shown) on the switching node and then to control logic 250 and scheduler 270 from the central processor.

It will be appreciated by those of ordinary skill in the art that the invention can be embodied in other specific forms without departing from the spirit or essential character hereof. The present invention is therefore considered in all respects to be illustrative and not restrictive. The scope of the invention is indicated by the appended claims, and all changes that come within the meaning and range of equivalents thereof are intended to be embraced therein.

I claim:

1. A metering and marking method for a packet-based network, comprising:
assigning a first precedence to a packet in a data stream if the data stream exceeds a high boundary rate;
assigning a second precedence to the packet in the data stream if the data stream exceeds a first intermediate rate but does not exceed the high boundary rate;
assigning a third precedence to the packet in the data stream if the data stream exceeds a low boundary rate but does not exceed a second intermediate rate;
assigning a fourth precedence to the packet in the data stream if the data stream does not exceed the low boundary rate; and
marking the packet based on the assigned precedence,
wherein the second precedence provides a higher level of assurance than the first precedence, the third precedence provides a higher level of assurance than the second precedence and the fourth precedence provides a higher level of assurance than the third precedence.

2. The method of claim 1, wherein the first and second intermediate rates are the same rate.

3. The method of claim 1, wherein the first and second intermediate rates are different rates.

4. The method of claim 1, wherein the high boundary rate is a peak information rate and the low boundary rate is a committed information rate.

5. A packet switching node, comprising:
a meter for assigning one of at least four predetermined precedences to a packet within a data stream based on a comparison of at least one measured rate for the data stream with at least one of at least three predetermined limit rates for the data stream; and
a marker for marking the packet based on the assigned precedence.

6. The packet switching node of claim 5, wherein the precedences include a first precedence, a second precedence associated with a higher level of assurance than the first precedence, a third precedence associated with a higher level of assurance than the second precedence and a fourth precedence associated with a higher level of assurance than the third precedence.

7. The packet switching node of claim 6, wherein the limit rates include a low boundary rate, an intermediate rate and a high boundary rate.

8. The packet switching node of claim 7, wherein the comparison includes a comparison of at least one of the measured rates with the high boundary rate and wherein the packet is assigned the first precedence if the comparison indicates the high boundary rate is exceeded.

9. The packet switching node of claim 7, wherein the comparison includes a first comparison of at least one of the measured rates with the high boundary rate and a second comparison of at least one of the measured rates with the intermediate rate and wherein the packet is assigned the second precedence if the comparison indicates the high boundary rate is not exceeded and the intermediate rate is exceeded.

10. The packet switching node of claim 7, wherein the comparison includes a first comparison of at least one of the measured rates with the intermediate rate and a second comparison of at least one of the measured rates with the low boundary rate and wherein the packet is assigned the third precedence if the comparison indicates the intermediate rate is not exceeded and the low boundary rate is exceeded, and is assigned the fourth precedence if the comparison indicates the low boundary rate is not exceeded.

11. The packet switching node of claim 5, wherein the data stream is associated with a particular priority.

12. The packet switching node of claim 5, wherein the assignment is further based on a preexisting precedence associated with the packet and the assigned precedence is associated with a level of assurance no higher than the preexisting precedence.

13. The packet switching node of claim 5, wherein the number of limit rates is configurable.

14. A metering and marking method for a packet-based network, comprising:
measuring at least one rate of a data stream;
comparing at least one of the measured rates with at least one of at least three predetermined limit rates;
assigning one of at least four predetermined precedences to a packet within the data stream based on the comparison; and
marking the packet based on the assigned precedence.

15. The method of claim 14, wherein the precedences include a first precedence, a second precedence associated with a higher level of assurance than the first precedence, a third precedence associated with a higher level of assurance than the second precedence and a fourth precedence associated with a higher level of assurance than the third precedence.

16. The method of claim 15, wherein the first precedence is assigned if the comparison indicates the data stream exceeds the high boundary rate.

17. The method of claim 15, wherein the second precedence is assigned if the comparison indicates the data stream exceeds the intermediate rate but does not exceed the high boundary rate.

18. The method of claim 15, wherein the third precedence is assigned if the comparison indicates the data stream exceeds the low boundary rate but does not exceed the intermediate rate.

19. The method of claim 15, wherein the fourth precedence is assigned if the comparison indicates the data stream does not exceed the low boundary rate.

20. The method of claim 14, wherein the data stream is associated with a particular priority.

21. The method of claim 14, wherein the assignment is further based on a preexisting precedence associated with the packet and the assigned precedence is associated with a level of assurance no higher than the preexisting precedence.

22. The method of claim 14, wherein the number of limit rates is configurable.

23. An N rate, N+1 precedence meter/marker for a packet switching node wherein N is a configurable number which is at least three.
